(19) United States
(12) Patent Application Publication
(10) Pub. No.: US 2024/0071677 A1
(43) Pub. Date: Feb. 29, 2024

(54) INDUCTOR AND METHOD FOR MANUFACTURING INDUCTOR

(71) Applicant: Murata Manufacturing Co., Ltd., Kyoto-fu (JP)

(72) Inventors: Keita MUNEUCHI, Nagaokakyo-shi (JP); Takehiro YAWATA, Nagaokakyo-shi (JP)

(73) Assignee: Murata Manufacturing Co., Ltd., Kyoto-fu (JP)

(21) Appl. No.: 18/366,504

(22) Filed: Aug. 7, 2023

(30) Foreign Application Priority Data
Aug. 30, 2022 (JP) 2022-136630

(51) Int. Cl. H01F 27/255; H01F 27/28; H01F 27/32; H01F 41/02; H01F 41/10

(52) U.S. Cl. CPC H01F 27/255; H01F 27/2823; H01F 27/32; H01F 41/0246; H01F 41/10; H01F 27/292

(57) ABSTRACT

An inductor includes a base body including a coil conductor and a core in which the coil conductor is embedded. The coil conductor includes a wound band-shaped conductive wire, and the core contains magnetic particles and a resin. The band-shaped conductive wire has a cross-sectional shape including principal faces that are parallel to each other and end faces that connect the principal faces to each other. The coil conductor is formed by winding the band-shaped conductive wire having a covering layer including an insulating layer and a fusion layer. The insulating layer covers a surface of the band-shaped conductive wire. The fusion layer covers the insulating layer. A recess defined by the insulating layer is in an end face of a wound section, in which the band-shaped conductive wire is wound, in an axial direction, and is at least partially filled with a resin of the fusion layer.

### CROSS-REFERENCE TO RELATED APPLICATION

This application claims benefit of priority to Japanese Patent Application No. 2022-136630, filed Aug. 30, 2022, the entire content of which is incorporated herein by reference.

### BACKGROUND

### Technical Field

The present disclosure relates to an inductor and a method for manufacturing the inductor.

### Background Art

Japanese Unexamined Patent Application Publication No. 2016-58418 describes a process of manufacturing a coil component including a base body (magnetic body) containing magnetic particles and a resin, a coil conductor embedded in the base body, and a pair of outer electrodes electrically connected to the ends of the coil conductor. In this process, the coil conductor is formed by winding a conductive wire having an insulation coating to form a wound section and extending both ends of the conductive wire from an outer periphery of the wound section.

In the wound section of the coil conductor embedded in the base body, turns of the conductor are arranged in an axial direction of the wound section, and recesses are formed at boundaries between the turns of the conductor. The coil conductor is formed of a flat rectangular conductive wire having an insulation coating that is thinner in regions around the four corners than in other regions. Therefore, the conductor is close to the magnetic particles at positions deep in the recesses where the corners of the flat rectangular conductive wire are positioned, and the insulation may be reduced compared to that at locations other than the recesses. Therefore, it is desirable to increase the insulation at the above-described recesses to improve the withstand performance of an inductor.

### SUMMARY

Accordingly, the present disclosure provides an inductor including a base body containing magnetic particles and a coil conductor embedded in the base body and formed by winding a conductor having an insulation coating. The inductor has withstand performance improved by increasing the insulation between the coil conductor and the magnetic particles.

According to an aspect of the present disclosure, an inductor includes a base body including a coil conductor and a core in which the coil conductor is embedded. The coil conductor includes a band-shaped conductive wire that is wound, and the core contains magnetic particles and a resin. The band-shaped conductive wire has a cross-sectional shape including a pair of principal faces that are parallel to each other and a pair of end faces that connect the principal faces to each other. The coil conductor is formed by winding the band-shaped conductive wire provided with a covering layer including an insulating layer and a fusion layer, the insulating layer covering a surface of the band-shaped conductive wire, the fusion layer covering the insulating layer. A recess defined by the insulating layer is formed in an end face of a wound section, in which the band-shaped conductive wire is wound, in an axial direction, and the recess is at least partially filled with a resin of the fusion layer.

According to another aspect of the present disclosure, a method for manufacturing an inductor includes a coil conductor formation step of forming a coil conductor by winding a band-shaped conductive wire; a base body molding step of molding a base body by embedding the coil conductor in a core containing magnetic particles and a resin and compressing the core. The coil conductor is embedded such that a surface of an extended section extending from a wound section of the coil conductor is exposed on a surface of the core; a surface treatment step of treating surfaces of the base body and the extended section. The method further includes a plating step of forming an outer electrode on the extended section. In the coil conductor formation step, the coil conductor is formed by winding the band-shaped conductive wire provided with a covering layer including an insulating layer and a fusion layer, the insulating layer covering a surface of the band-shaped conductive wire, the fusion layer covering the insulating layer. In at least one of the coil conductor formation step and the base body molding step, a recess covered with the insulating layer is formed in an end face of a wound section, in which the band-shaped conductive wire is wound, in an axial direction, and the recess is at least partially filled with a resin of the fusion layer.

According to the present disclosure, the recess formed in the wound section of the coil conductor is filled with the resin of the fusion layer, so that entrance of the magnetic particles into the recess can be impeded. Accordingly, the insulation between the coil conductor and the magnetic particles can be increased, and the withstand performance of the inductor can be improved accordingly.

### BRIEF DESCRIPTION OF THE DRAWINGS

FIG. 1 is a perspective view of an inductor according to an embodiment of the present disclosure viewed from above a top face;

FIG. 2 is a perspective view of the inductor viewed from below a bottom face;

FIG. 3 is a see-through perspective view illustrating the internal structure of the inductor;

FIG. 4 is a flowchart of steps for manufacturing the inductor;

FIG. 5 is a sectional view of a coil conductor taken along a plane extending in a thickness direction;

FIG. 6 is a sectional view taken along line A-A in FIG. 3;

FIG. 7 illustrates details of part Pin the sectional view of FIG. 6; and

FIG. 8 is a micrograph of a cross section of a base body illustrating an example of a recess.

### DETAILED DESCRIPTION

An embodiment of the present disclosure will be described with reference to the drawings.

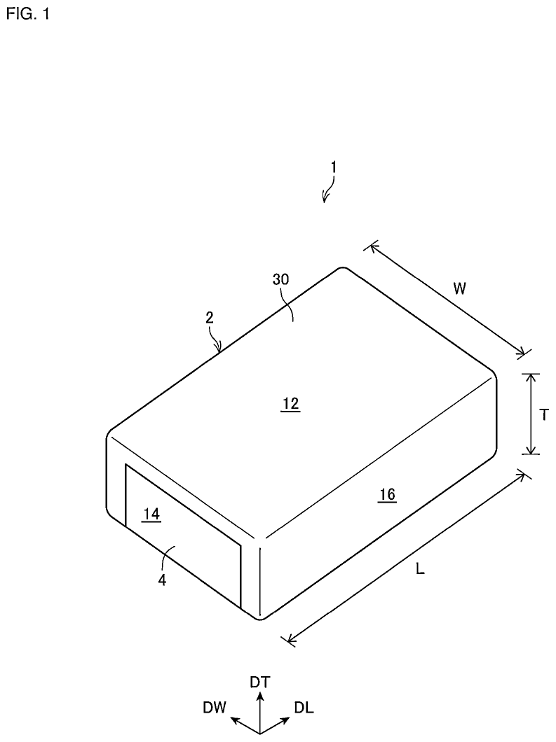

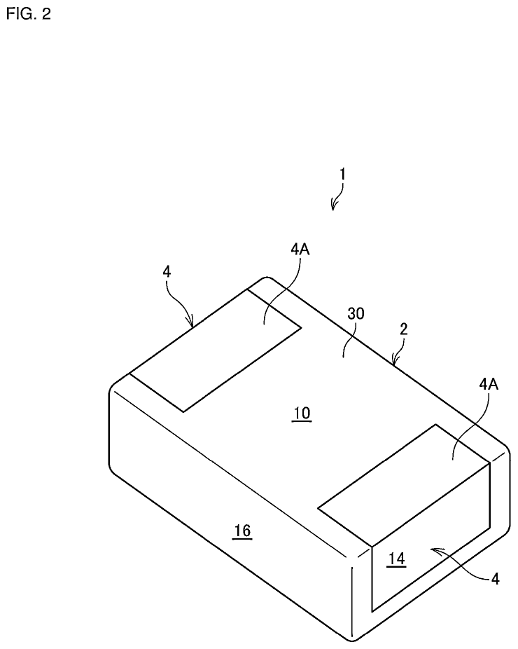

FIG. 1 is a perspective view of an inductor according to the present embodiment viewed from above a top face 12. FIG. 2 is a perspective view of the inductor viewed from below a bottom face 10.

The inductor according to the present embodiment is configured as a surface-mounted electronic component, and includes a base body 2 having a substantially rectangular parallelepiped shape, which is an example of a substantially hexahedron shape, and a pair of outer electrodes 4 provided on a surface of the base body 2.

In the following description, a first principal face of the base body 2 that faces a mounting board (not illustrated) in a mounting process is defined as the bottom face 10, a second principal face that is opposite to the bottom face 10 as the top face 12, a pair of third principal faces orthogonal to the bottom face 10 as end faces 14, and a pair of fourth principal faces orthogonal to the bottom face 10 and the pair of end faces 14 as side faces 16.

As illustrated in FIG. 1, the distance from the bottom face 10 to the top face 12 is defined as a thickness T of the base body 2, the distance between the pair of side faces 16 as a width W of the base body 2, and the distance between the pair of end faces 14 as a length L of the base body 2. The direction of the thickness T is defined as a thickness direction DT, the direction of the width W as a width direction DW, and the direction of the length L as a length direction DL. The thickness direction DT is a direction normal to the top face 12 and the bottom face 10. The width direction DW is a direction normal to the side faces 16. The length direction DL is a direction normal to the end faces 14.

The inductor has, for example, a length L of 2.0 mm, a width W of 1.6 mm, and a thickness T of 1.1 mm.

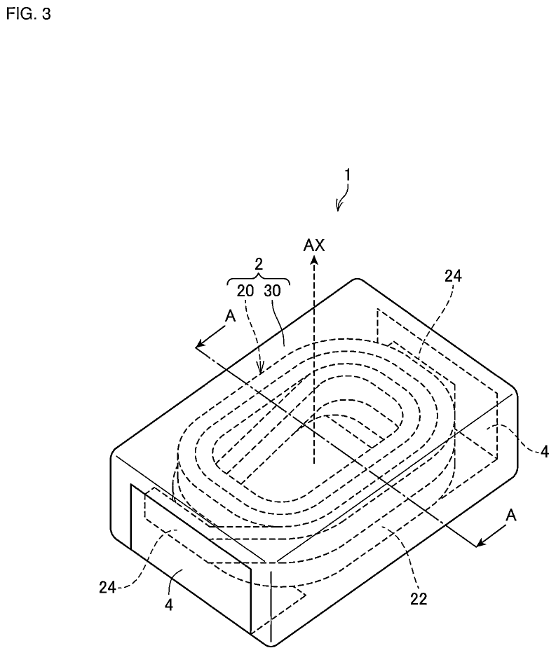

FIG. 3 is a see-through perspective view illustrating the internal structure of the inductor.

The base body 2 includes a coil conductor 20 and a core 30 having a substantially hexahedron shape in which the coil conductor 20 is embedded. The base body 2 is configured as a molded inductor in which the coil conductor 20 is sealed in the core 30.

The core 30 is a compression-molded body formed in a substantially hexahedron shape by applying heat and pressure to mixed powder containing soft magnetic particles and a resin while the coil conductor 20 is embedded in the mixed powder.

In the present embodiment, the magnetic particles contain two types of particles having different particle sizes: first magnetic particles that are large particles having a relatively large average particle size, and second magnetic particles that are small particles having a relatively small average particle size. Accordingly, during compression molding, the second magnetic particles, which are small particles, enter the spaces between the first magnetic particles, which are large particles, together with the resin. Thus, the packing fraction of the magnetic particles in the core 30 can be increased, and the core 30 can have a higher magnetic permeability.

In the present embodiment, the first magnetic particles and the second magnetic particles include metal particles having average particle sizes of 24.4 μm and 1.7 μm respectively. The average particle size of the first magnetic particles is preferably 7 μm or more and 60 μm or less (i.e., from 7 μm to 60 μm), and the average particle size of the second magnetic particles is preferably 1 μm or more and 4 μm or less (i.e., from 1 μm to 4 μm). The magnetic particles may further contain particles having an average particle size different from those of the first magnetic particles and the second magnetic particles. Thus, the magnetic particles may contain three or more types of particles having different particle sizes.

Both the first magnetic particles and the second magnetic particles are particles including metal particles whose surfaces are covered with an insulating film having a film thickness of several nanometers or more and several tens of nanometers or less (i.e., from several nanometers to several tens of nanometers). Since the metal particles are covered with the insulating film, the insulation resistance and the withstand voltage can be increased.

The first magnetic particles according to the present embodiment are formed by using Fe—Si—B amorphous alloy powder as the metal particles and a film of zinc phosphate glass having a thickness of 10 nm or more and 50 nm or less (i.e., from 10 nm to 50 nm) as the insulating film. The second magnetic particles according to the present embodiment are formed by using carbonyl iron powder as the metal particles and a silica film having a thickness of 5 nm or more and 15 nm or less (i.e., from 5 nm to 15 nm) as the insulating film.

The material of the resin contained in the mixed powder according to the present embodiment is an epoxy resin containing phenol alkyl epoxy resin as the base resin.

In the present embodiment, the mixed powder contains 75±10 wt % of the first magnetic particles, 25±10 wt % of the second magnetic particles, and 2.7 wt % or more and 3.5 wt % or less (i.e., from 2.7 wt % to 3.5 wt %) of the resin.

As illustrated in FIG. 3, the coil conductor 20 includes a wound section 22 in which a conductive wire is wound and a pair of extended sections 24 extending from the wound section 22.

The coil conductor 20 includes the conductive wire and a covering layer formed on a surface of the conductive wire. The conductive wire is a band-shaped conductive wire (so-called flat conductive wire) made of copper and having a rectangular cross section. The conductive wire has a thickness of 18 μm or more and 90 μm or less (i.e., from 18 μm to 90 μm) and a width of 240 μm or more and 340 μm or less (i.e., from 240 μm to 340 μm). The covering layer includes an insulating layer formed on a surface of the band-shaped conductive wire and a fusion layer formed on a surface of the insulating layer. The fusion layer serves to join overlapping portions of the band-shaped conductive wire in the wound section 22. The insulating layer is made of a polyimide-amide resin and has a thickness of 6±2 μm. The fusion layer is made of a polyimide resin and has a thickness of 2.5±1.0 μm. The coil conductor may have curved thickness surfaces. When the thickness surfaces are curved, the width of the conductive wire covers the regions in which the thickness surfaces are curved.

The wound section 22 of the coil conductor 20 is formed by winding the conductive wire in a helical shape so that both ends of the band-shaped conductive wire (hereinafter also referred to simply as a conductive wire) extend to the outer periphery and that portions thereof are connected to each other at the inner periphery. In the base body 2, the coil conductor 20 is embedded in the core 30 in an orientation such that a central axis of the wound section 22 extends in the thickness direction DT of the base body 2. The extended sections 24 extend from the wound section 22 to respective ones of the pair of end faces 14. One principal face of the band-shaped conductive wire of each extended section 24 is exposed on the base body 2, and the other principal face is embedded in the base body 2. The one principal face of the band-shaped conductive wire of each extended section 24 that is exposed on the base body 2 is electrically connected to a corresponding one of the outer electrodes 4. In FIG. 3, an axis of the wound section 22 is denoted by AX. The axis AX extends in, for example, the thickness direction DT of the inductor 1. The coil conductor 20 is wound around the axis AX in the wound section 22, and the number of turns the coil conductor 20 is wound is determined based on the number of turns of the inductor 1.

Each of the pair of outer electrodes 4 is a so-called L-shaped electrode composed of an L-shaped member extending from a corresponding one of the end faces 14 of the base body 2 to the bottom face 10. The outer electrodes 4 are connected to respective ones of the extended sections 24 of the coil conductor 20 on the end faces 14. Portions 4A (FIG. 2) of the outer electrodes 4 extending along the bottom face 10 are electrically connected to wiring lines on a circuit board by appropriate mounting means, such as solder.

A base-body protection layer (not illustrated) is formed on the surface of the base body 2 over regions excluding the regions in which the outer electrodes 4 are provided. The base-body protection layer is made of, for example, a phenoxy resin and a novolak resin and contains nano silica as a filler. The base-body protection layer is formed on the surface of the base body 2 to a thickness of 10 μm or more and 30 μm or less (i.e., from 10 μm to 30 In).

According to the inductor having the above-described structure, direct-current superposition characteristics can be improved by using magnetic particles made of a soft magnetic material. Accordingly, the inductor may be used as an electronic component of an electric circuit through which a large current flows, or as a choke coil of a DC-DC converter circuit or a power supply circuit. The inductor may also be used as an electronic component of an electronic device, such as a personal computer, a DVD player, a digital camera, a television set, a cellular phone, a smartphone, a car electronic device, or a medical or industrial device. The application of the inductor is not limited to this, and the inductor may also be used in, for example, a tuning circuit, a filter circuit, or a rectifying-smoothing circuit.

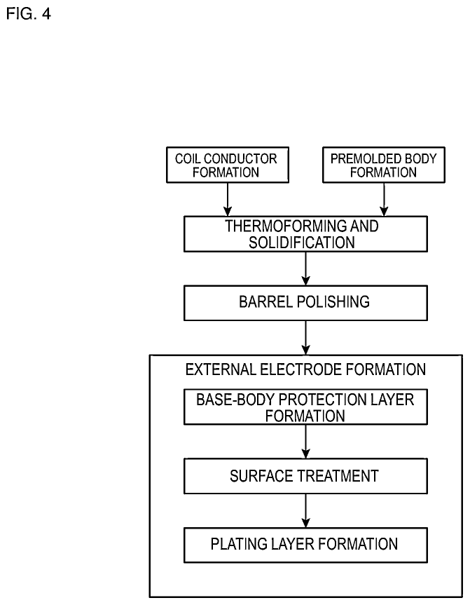

FIG. 4 is a flowchart of steps for manufacturing the inductor.

As illustrated in FIG. 4, the steps for manufacturing the inductor includes a coil conductor formation step, a premolded body formation step, a thermoforming-and-solidification step, a barrel polishing step, and an outer electrode formation step.

In the coil conductor formation step, the conductive wire is formed into the coil conductor 20. In this step, the coil conductor 20 having a shape including the above-described wound section 22 and the pair of extended sections 24 is formed by winding the conductive wire by a winding method called “alpha winding” (a winding). Alpha winding is a winding method in which the conductive wire, which serves as a conductor, is spirally wound in each layer of two layers so that the extended sections 24 at the starting and finishing ends are positioned at the outer periphery. The number of turns of the coil conductor 20 is not particularly limited.

In the premolded body formation step, premolded bodies called tablets are formed.

The premolded bodies are bodies formed by compressing the above-described mixed powder, which is the material of the base body 2, into a solid shape that is easy to handle. In the present embodiment, two types of tablets, which are a first tablet and a second tablet, are formed. The first tablet has an appropriate shape (for example, an E-shape) including a groove for receiving the coil conductor 20. The second tablet has an appropriate shape (for example, an I-shape or a plate shape) that covers the groove in the first tablet.

In the thermoforming-and-solidification step, the first tablet, the coil conductor 20, and the second tablet are placed in a mold and pressed in a direction in which the first and second tablets are stacked while heat is applied thereto, so that the first and second tablets are solidified. As a result, the first tablet, the coil conductor 20, and the second tablet are integrated together. Thus, the base body 2 in which the coil conductor 20 is embedded in the core 30 is formed.

The thermoforming-and-solidification step corresponds to a base body molding step in the present disclosure.

In the barrel polishing step, the molded body is subjected to barrel polishing. As a result of this step, the corners of the base body 2 are rounded.

In the outer electrode formation step, the outer electrodes 4 are formed on the core 30. The outer electrode formation step includes a base-body protection layer formation step, a surface treatment step, and a plating layer formation step.

In the base-body protection layer formation step, the surface of the molded body is coated with an insulating resin. As a result of this step, a base-body protection layer made of the insulating resin is formed, for example, over the entire surface of the molded body.

In the surface treatment step, the surface of the core 30 is irradiated with laser light in electrode formation regions, so that the surface is reformed in the electrode formation regions. The electrode formation regions are regions of the surface of the core 30 in which the outer electrodes 4 are to be formed. These regions include regions in which the extended sections 24 are exposed. More specifically, the surface of the core 30 is irradiated with laser light so that, in the electrode formation regions, the base-body protection layer on the surface of the core 30 and the covering layer of the extended sections 24 of the coil conductor 20 are removed. In addition, the resin on the surface of the core 30 is removed, and the insulating film on the surfaces of the magnetic particles exposed on the core 30 is also removed. As a result, the area of the regions in which the metal of the magnetic particles is exposed on the surface of the core 30 per unit area is greater in the electrode formation regions than in other regions of the surface of the core 30. After the irradiation with laser light, a cleaning process (for example, an etching process) may be performed to clean the surface in the electrode formation regions.

In the plating layer formation step, the surface of the core 30 is plated with copper by barrel plating, so that a copper plating layer is formed in the electrode formation regions that have been irradiated with laser light. A Ni plating layer and a Sn plating layer may be additionally formed on the copper plating layer.

As a result of the above-described outer electrode formation step, the outer electrodes 4 composed of the above-described plating layers are formed.

Each outer electrode 4 is not limited to the L-shaped electrode, and may be a so-called five-sided electrode that extends over the entirety of the corresponding end face 14 and portions of the bottom face 10, the top face 12, and the pair of side faces 16 adjacent to the end face 14. When the five-sided electrode is formed by dipping the core 30 into a conductive resin, it is not necessary to perform the base-body protection layer formation step.

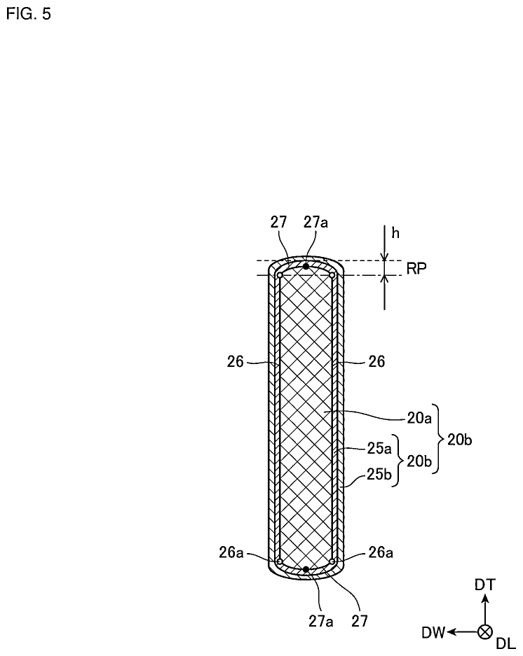

FIG. 5 is a sectional view of the coil conductor 20 according to the present embodiment taken along a plane extending in the thickness direction (that is, a plane orthogonal to the length direction) before the coil conductor 20 is wound. The coil conductor 20 includes a band-shaped conductive wire 20a and a covering layer 20b formed on a surface of the band-shaped conductive wire 20a. The covering layer 20b includes an insulating layer 25a formed on the surface of the band-shaped conductive wire 20a and a fusion layer 25b formed on a surface of the insulating layer 25a. Note that, in FIG. 5, white and black circles represent lines extending in a direction normal to the plane of FIG. 5.

The band-shaped conductive wire 20a has two principal faces 26 that are opposite to each other and two side faces 27 that are adjacent to the principal faces 26 and opposite to each other. In the cross-sectional view of the band-shaped conductive wire 20a taken along the thickness direction illustrated in FIG. 5, the two side faces 27 are convexly curved toward the outside of the band-shaped conductive wire 20a and have ridge lines 27a (positions shown by black circles). Assume that a plane passing through boundaries 26a (positions shown by white circles in FIG. 5) between each side face 27 and the flat principal faces 26 and orthogonal to the principal faces 26 is a reference plane RP. The distance from the reference plane RP to the insulating layer 25a on the corresponding ridge line 27a of the band-shaped conductor (height to the apex of the insulating layer 25a) is defined as a height h of the ridge line. The height h is, for example, 8 μm or more.

In the above-described coil conductor formation step, the coil conductor 20 is heated while being wound into a shape including the wound section 22 and the extended sections 24. When the coil conductor 20 is heated and wound, the fusion layers 25b on adjacent turns of the coil conductor 20 in the wound section 22 are pressure bonded together, so that two adjacent portions of the coil conductor 20 are joined together by the fusion layers 25b and the wound section 22 is formed to have an integral structure.

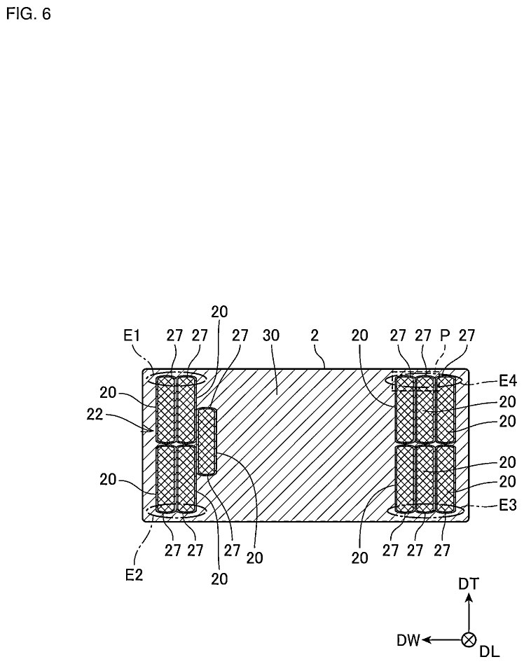

FIG. 6 is a sectional view taken along line A-A in FIG. 3. As illustrated in FIG. 6, in the wound section 22, a plurality of turns of the coil conductor 20 in the wound section 22 are arranged in a direction crossing the axis AX. The side faces 27 of respective turns of the coil conductor 20 are arranged along end faces of the wound section 22 in the axis AX direction, and are in contact with the mixture of the magnetic particles and the resin of the base body 2.

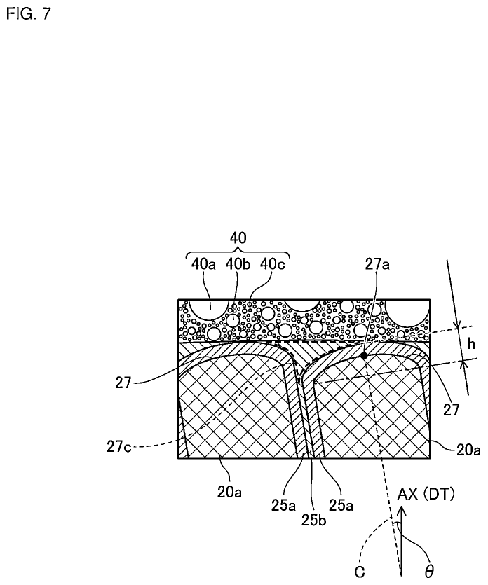

FIG. 7 is an enlarged view of part P in FIG. 6. In FIG. 7, a center line of the coil conductor 20 in the width direction is denoted by C. The center line C is a straight line extending along a plane parallel to the principal faces 26. The center line C is inclined with respect to the axis AX at an angle θ. The inclination occurs when a pressure is applied to the wound section 22 in the coil conductor formation step and/or the thermoforming-and-solidification step. The angle θ is, for example, −15° to +15°.

The insulating layer 25a on one turn of the coil conductor 20 is joined to an adjacent turn of the coil conductor 20 by the fusion layer 25b while the band-shaped conductive wire 20a remains covered by the insulating layer 25a. In the coil conductor formation step, a portion of the fusion layer 25b moves out of the space between the adjacent portions of the coil conductor 20 in the axis AX direction and reaches the side faces 27. The deformation of the fusion layer 25b may occur not only in the coil conductor formation step but also in the thermoforming-and-solidification step.

On each end face of the wound section 22 in the axis AX direction, a recess 27c is formed between the side face 27 of one turn of the coil conductor 20 and the side face 27 of an adjacent turn of the coil conductor 20. As described above, the side faces 27 of the band-shaped conductive wire 20a are convexly curved toward the outside of the band-shaped conductive wire 20a. The recess 27c has a substantially triangular cross section and is formed due to the curved side faces 27. For example, the recess 27c formed between two adjacent portions of the coil conductor 20 in the wound section 22 is a space surrounded by a plane connecting the apices of the insulating layers 25a on the side faces 27 of the two portions of the coil conductor 20 (although not illustrated, the apices are points on the surfaces of the insulating layers 25a and above the ridge lines 27a) and the surfaces of the insulating layers 25a on the two portions of the coil conductor 20. Although not illustrated, the recess 27c extends in a direction orthogonal to the plane of FIG. 7, that is, along the side faces 27 in the longitudinal direction of the coil conductor 20. It is not necessary that the side faces of the coil conductor 20 be curved. Even when, for example, the side faces of the coil conductor 20 are straight or flat, an irregular portion similar to the recess 27c can be formed simply by tilting the center line C in the width direction.

As described above, magnetic particles 40 contained in the base body 2 include first magnetic particles 40a, which are large particles, and second magnetic particles 40b and 40c, which are small particles. The second magnetic particles 40c are small particles having particularly small particle sizes. This is merely an example, and it is not necessary that the magnetic particles 40 include particles having different particle sizes corresponding to the second magnetic particles 40b and 40c. The magnetic particles 40 are mixed with the resin to form the core 30 after the particle sizes thereof are adjusted. The recess 27c is, for example, a space larger than the second magnetic particles 40b and 40c, and therefore the second magnetic particles 40b and 40c enter the recess 27c in the thermoforming-and-solidification step.

Since the coil conductor 20 is covered by the insulating layer 25a, the coil conductor 20 remains insulated even when the second magnetic particles 40b and 40c enter the recess 27c. However, the insulating layer 25a is thinner at the recess 27c than at other locations, and therefore the insulation between the band-shaped conductive wire 20a and the magnetic particles 40 is easily reduced compared to that at locations other than the recess 27c. In the structure illustrated in FIG. 7, the fusion layer 25b that moves out of the space between the adjacent portions of the coil conductor 20 in the wound section 22 enters the recess 27c and at least partially fills the recess 27c. Since the recess 27c is filled with the fusion layer 25b, the entrance of the magnetic particles 40 into the recess 27c is impeded. Therefore, the degree of insulation is maintained sufficiently high at the recess 27c, and the withstand performance of the inductor 1 can be increased.

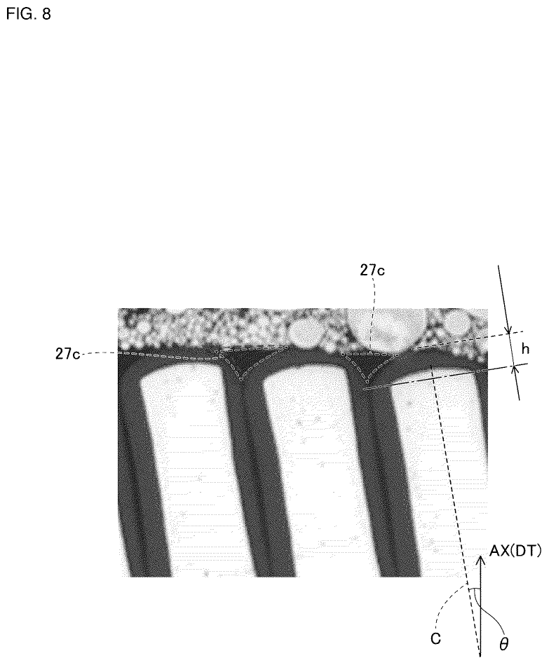

FIG. 8 is a micrograph of a region corresponding to the sectional view of FIG. 7. Since the boundaries between the insulating layer 25a and the fusion layer 25b are not clear in the micrograph of FIG. 8, the recesses 27c are outlined by the dotted lines in FIG. 8. As shown in FIG. 8, each of the recesses 27c formed in an outer peripheral region of the wound section 22 is at least partially filled with the fusion layer 25b. Therefore, the magnetic particles 40 dot not easily reach deep regions of the recesses 27c.

In the present embodiment, the fusion layer 25b serves as a resin that fills the recesses 27c to impede entrance of the magnetic particles 40 into the recesses 27c. The fusion layer 25b moves out of the space between two adjacent portions of the band-shaped conductive wire 20a and enters the corresponding recess 27c in the coil conductor formation step and/or the thermoforming-and-solidification step. The amount or percentage of the cross-sectional area occupied by the fusion layer 25b in each recess 27c is adjustable by adjusting, for example, the thicknesses of the fusion layer 25b and the insulating layer 25a, the pressure applied in the winding process, and the height h of the ridge line. Therefore, it is not necessary to perform a step of filling the recesses 27c with an insulating material, and it is not necessary to prepare an insulating material other than the coil conductor 20. Accordingly, the withstand performance of the inductor 1 can be improved without increasing the number of steps for manufacturing the inductor 1.

It is not necessary that the amount of the fusion layer 25b in each recess 27c be sufficient to completely fill the recess 27c as long as the fusion layer 25b at least partially occupies the recess 27c. For example, in the cross section of the base body 2 illustrated in FIGS. 7 and 8, the fusion layer 25b preferably occupies 30% or more of the cross-sectional area of each recess 27c. More preferably, the fusion layer 25b occupies 50% or more of the cross-sectional area of each recess 27c.

It is not necessary that all of the recesses 27c in the wound section 22 be filled with the fusion layer 25b. The recesses 27c are formed at positions where the side faces 27 face the magnetic particles 40 in the wound section 22. In particular, the effect of increasing the insulation is expected at positions close to the surface of the base body 2. More specifically, in FIG. 6, regions E1 and E4 are close to the top face 12, and regions E2 and E3 are close to the bottom face 10. It is effective to fill the recesses 27c with the fusion layer 25b in these region E1 to E4.

For example, when the base body is cut at the center of the length L thereof, four or more recesses 27c randomly selected from the plurality of recesses 27c in the regions E1 to E4 of the cross section may be filled with the fusion layer 25b. In such a case, the effect of increasing the insulation between the coil conductor 20 and the magnetic particles 40 in the inductor 1 can be expected. The fusion layer 25b preferably occupies 30% or more of the cross-sectional areas of the selected four or more recesses 27c on average. More preferably, the fusion layer 25b occupies 50% or more of the cross-sectional areas on average.

Also when at least one recess 27c is filled with the fusion layer 25b in all of the regions E1, E2, E3, and E4, the effect of increasing the insulation between the coil conductor 20 and the magnetic particles 40 in the inductor 1 can be expected. In this case, the fusion layer 25b preferably occupies 30% or more of the cross-sectional area of the recess 27c filled with the fusion layer 25b. More preferably, the fusion layer 25b occupies 50% or more of the cross-sectional area.

The cross-sectional area occupied by the fusion layer 25b in each recess 27c can be determined by using, for example, a micrograph of a cross section of the inductor 1 as illustrated in FIG. 7.

Note that each of the above-described embodiments and modifications is an example of one aspect of the present disclosure, and any modifications and applications are possible without departing from the spirit of the present disclosure. For example, in the above-described embodiment, the coil conductor 20 is formed by winding the conductive wire by a winding method referred to as a winding in the coil conductor formation step. However, this is merely an example, and the coil conductor 20 may be formed in a shape including the wound section 22 by winding a conductor by another method.

In addition, unless otherwise specified, directions, such as horizontal and vertical directions, various numerical values, shapes, and materials in the above-described embodiments include ranges (so-called equivalent ranges) in which the same effects as those of the directions, numerical values, shapes, and materials are obtained.

### Configurations Supported by the Embodiments

The above-described embodiments support the following configurations.

(Configuration 1) An inductor including a base body including a coil conductor and a core in which the coil conductor is embedded. The coil conductor includes a band-shaped conductive wire that is wound, and the core contains magnetic particles and a resin. The band-shaped conductive wire has a cross-sectional shape including a pair of principal faces that are parallel to each other and a pair of end faces that connect the principal faces to each other. The coil conductor is formed by winding the band-shaped conductive wire provided with a covering layer including an insulating layer and a fusion layer by an a winding method. The insulating layer covers a surface of the band-shaped conductive wire, and the fusion layer covers the insulating layer. A recess covered with the insulating layer is formed in an end face of a wound section, in which the band-shaped conductive wire is wound, in an axial direction, and the recess is at least partially filled with a resin of the fusion layer.

According to the inductor of Configuration 1, the recess formed when the band-shaped conductive wire is wound is filled with the fusion layer, which is a portion of the covering layer of the band-shaped conductive wire. Accordingly, the insulation between the band-shaped conductive wire and the magnetic particles at the recess can be increased. As a result, the withstand performance of the inductor can be improved.

(Configuration 2) The inductor according to Configuration 1, wherein the end faces of the band-shaped conductive wire are curved faces that are convex in the axial direction. According to the inductor of Configuration 2, the recess formed because the end faces of the band-shaped conductive wire are convex is filled with the fusion layer so that the insulation between the band-shaped conductive wire and the magnetic particles at the recess can be increased.

(Configuration 3) The inductor according to Configuration 2, wherein an apex of the insulating layer covering each end face is at a height of 8 μm or more from a reference plane of the band-shaped conductive wire, the reference plane being a plane passing through boundary points between the end face and the principal faces and orthogonal to the principal faces.

According to the inductor of Configuration 3, when the recess defined by the insulating layers of two adjacent portions of the band-shaped conductive wire is formed because the end faces of the band-shaped conductive wire are curved, the insulation between the band-shaped conductive wire and the magnetic particles at the recess can be increased.

(Configuration 4) The inductor according to any one of Configurations 1 to 3, wherein, in a cross section of the base body, the resin of the fusion layer occupies an area that is 30% or more of a cross-sectional area of the recess.

According to the inductor of Configuration 4, since the fusion layer occupies 30% or more of the cross-sectional area of the recess, the insulation between the band-shaped conductive wire and the magnetic particles at the recess can be more reliably increased.

(Configuration 5) A method for manufacturing an inductor, the method including: a coil conductor formation step of forming a coil conductor by winding a band-shaped conductive wire; and a base body molding step of molding a base body by embedding the coil conductor in a core containing magnetic particles and a resin and compressing the core. The coil conductor is embedded such that a surface of an extended section extending from a wound section of the coil conductor is exposed on a surface of the core. The method further includes a surface treatment step of treating surfaces of the base body and the extended section; and a plating step of forming an outer electrode on the extended section. In the coil conductor formation step, the coil conductor is formed by winding the band-shaped conductive wire provided with a covering layer including an insulating layer and a fusion layer. The insulating layer covers a surface of the band-shaped conductive wire, the fusion layer covers the insulating layer. In at least one of the coil conductor formation step and the base body molding step, a recess covered with the insulating layer is formed in an end face of a wound section, in which the band-shaped conductive wire is wound, in an axial direction, and the recess is at least partially filled with a resin of the fusion layer.

According to the method for manufacturing the inductor of Configuration 5, the recess formed when the band-shaped conductive wire is wound is filled with the fusion layer, which is a portion of the covering layer of the band-shaped conductive wire. Accordingly, the insulation between the band-shaped conductive wire and the magnetic particles at the recess can be increased, and the withstand performance of the inductor can be improved.

What is claimed is:

1. An inductor comprising:
a base body including a coil conductor and a core in which the coil conductor is embedded, the coil conductor including a band-shaped conductive wire that is wound, the core containing magnetic particles and a resin,
wherein
the band-shaped conductive wire has a cross-sectional shape including a pair of principal faces that are parallel to each other and a pair of end faces that connect the principal faces to each other,
wherein the coil conductor is configured by winding the band-shaped conductive wire having a covering layer including an insulating layer and a fusion layer, the insulating layer covering a surface of the band-shaped conductive wire, the fusion layer covering the insulating layer, and
a recess defined by the insulating layer is in an end face of a wound section, in which the band-shaped conductive wire is wound, in an axial direction, and the recess is at least partially filled with a resin of the fusion layer.

2. The inductor according to claim 1, wherein
the end faces of the band-shaped conductive wire are curved faces that are convex in the axial direction.

3. The inductor according to claim 2, wherein
an apex of the insulating layer covering each end face is at a height of 8 μm or more from a reference plane of the band-shaped conductive wire, the reference plane being a plane passing through boundary points between the end face and the principal faces and orthogonal to the principal faces.

4. The inductor according to claim 1, wherein
in a cross section of the base body, the resin of the fusion layer occupies an area that is 30% or more of a cross-sectional area of the recess.

5. The inductor according to claim 2, wherein
in a cross section of the base body, the resin of the fusion layer occupies an area that is 30% or more of a cross-sectional area of the recess.

6. The inductor according to claim 3, wherein
in a cross section of the base body, the resin of the fusion layer occupies an area that is 30% or more of a cross-sectional area of the recess.

7. A method for manufacturing an inductor, the method comprising:
forming a coil conductor by winding a band-shaped conductive wire;
molding a base body by embedding the coil conductor in a core containing magnetic particles and a resin and compressing the core, the coil conductor being embedded such that a surface of an extended section extending from a wound section of the coil conductor is exposed on a surface of the core;
treating surfaces of the base body and the extended section; and
forming an outer electrode on the extended section,
wherein, in the coil conductor formation, the coil conductor is formed by winding the band-shaped conductive wire having a covering layer including an insulating layer and a fusion layer, the insulating layer covering a surface of the band-shaped conductive wire, the fusion layer covering the insulating layer, and
wherein, in at least one of the coil conductor formation and the base body molding, a recess defined by the insulating layer is in an end face of a wound section, in which the band-shaped conductive wire is wound, in an axial direction, and the recess is at least partially filled with a resin of the fusion layer.
